(19) United States
(12) Patent Application Publication
(10) Pub. No.: US 2012/0120012 A1
(43) Pub. Date: May 17, 2012

(54) METHOD FOR INPUTTING DIGITAL CHARACTERS

(76) Inventor: Victor J. Carlson, Canoga Park, CA (US)

(21) Appl. No.: 13/296,702

(22) Filed: Nov. 15, 2011

Related U.S. Application Data
(60) Provisional application No. 61/414,665, filed on Nov. 17, 2010.

(51) Int. Cl. G06F 3/041

(52) U.S. Cl. 345/173

(57) ABSTRACT

A method for inputting symbols into a data entry field of an electronic device includes displaying on the electronic device a start screen having a plurality of start zones. Each start zone has a plurality of symbols associated therewith. A start zone is selected using the electronic device, and an end screen having a plurality of end zones is displayed on the electronic device. Each end zone has assigned thereto a single symbol or function. When an end zone is selected using the electronic device, the symbol assigned to the selected end zone is inputted into the data entry field of the electronic device, in order to create a message, command, etc.

### BACKGROUND OF THE INVENTION

The present invention is generally directed to methodologies for data entry. More particularly, the present invention is directed to a method for inputting characters into a screen of an electronic device.

A typical desktop computer includes a display screen, a keyboard, and an enclosure housing the microprocessor, memory, and other electronic components. The keyboard and mouse are connected with the computer processor by means of a wired or wireless connection, such that the keyboard and mouse can be used to input data and commands into various windows displayed on the display screen. The keyboard is typically a QWERTY type of arrangement with a grouping of letters, punctuation, and space and function bars in a central dominant portion, a function and number row of keys along a top edge of the keyboard, and a 10-key or other arrangement on the right-hand side of the keyboard. When entering data, such as an Internet search command, the keyboard is used to type in the various words, characters, etc. needed. There are instances when the mouse can be used to either click on and activate links or open screens, such as a number pad on the display screen which can be actuated using the mouse, etc. However, the mouse typically requires that the user click a button for each number or character. Moreover, the entry of numbers or individual characters, such as alphanumeric characters, is unusual using the mouse as it is faster and easier to use the attached physical keyboard.

More recently, data entry is found on much smaller and more portable devices, such as smart phones, iPads, iTouches, and even more basic cellular phones having texting capabilities. There are many instances in which the entry of alphabetical or numerical characters or the like is necessary or desired on such devices. For example, the entry of a new telephone number requires the user to enter the digits of the telephone number before calling the number. In order to text, create email messages and the like the user must enter the various characters digitally into the electronic device in order to create the desired message. There are also other instances, such as using applications, browsing the Internet, etc. where entry of alphanumeric characters and the like is required.

Many of these phones and hand-held portable electronic devices include a small physical keyboard in order to accomplish this data entry. Typically, the keyboard is arranged in a QWERTY format, some of the keyboards having all of the alphanumeric and function buttons representing the various characters, while others omit less used characters and functions due to space constraints. As the hand-held devices have become smaller, so have the keyboards and the individual keys or buttons used to depress and enter the desired character. This has created some frustration on behalf of users who find it difficult to depress the selected key without depressing an adjoining key. This results in the user needing to back space or clear the inadvertently entered character and attempt to enter the proper character again.

In other instances, recent hand-held device technology has incorporated touch screens wherein the user can enter characters electronically using a keyboard which is presented on a touch screen. As the user presses the portion of the screen immediately above a “virtual key”, that particular character is selected and entered into the display line. Once again, the format of such virtual keyboards is of the QWERTY style, at least when entering alphabetical characters. However, many individuals have found these touch screen keyboards to have the same frustrations as that discussed above with respect to the actual miniature keyboards. That is, it is not uncommon for individuals to inadvertently depress the wrong virtual key on the touch screen due to the small size of the virtual keys, requiring backspacing or clearing of these characters.

Another limitation with such devices is that the device itself is typically held with both hands while the user's thumbs are used to depress the keys/buttons or virtual keys of the touch screen. Not only does this require both of the user's hands in order to operate the device and enter the required message, data, or command, for those individuals having large thumbs the frustrations described above with respect to inadvertently depressing the wrong button or virtual key is particularly commonplace and a source of frustration. As an entire QWERTY keyboard or the vast majority of the alphanumeric characters and some of the punctuation and function characters are displayed simultaneously, the keyboard, whether comprised of buttons or virtual, is quite small requiring the user to hold the device fairly close to his or her face in order to be able to discern and clearly view the buttons or virtual keys in order to enter the desired characters comprising the message, command, etc.

Accordingly, there is a continuing need for an alternative data entry method which addresses the concerns noted above. The present invention fulfills these needs, and provides other related advantages.

### SUMMARY OF THE INVENTION

The present invention resides in a method for inputting symbols, such as alphabetical characters, numbers, numeric symbols, punctuation symbols and mathematical symbols, into a data entry field of an electronic device. The method of the present invention overcomes the drawbacks indicated above.

The method of the present invention generally comprises the steps of displaying on the electronic device a start screen having a plurality of start zones, each start zone having a plurality of symbols associated therewith. The start screen may comprise a default start screen, or a selected start screen.

A start zone is selected using the electronic device. An end screen is then displayed on the electronic device which has a plurality of end zones. Each end zone has assigned thereto a single symbol of the plurality of symbols associated with the selected start zone. An end zone is selected using the electronic device. The symbol assigned to the selected end zone is inputted into the data entry field of the electronic device. Once a symbol has been inputted into the data entry field, the invention may automatically return to the start screen or default start screen.

An area may be included in at least the end screen, and typically the start and end screens, which comprises the data entry field. Alternatively, at least the end screen, and typically the start screen and end screen, are semi-transparent and at least partially overlays the data entry field. The transparency of the screen may be selectively altered.

An edit screen may be selected, such that the electronic device displays an edit screen having a plurality of edit zones. Each edit zone is assigned an edit function. When the edit zone is selected, the selecting of the edit zone results in the assigned edit function being performed in the data entry screen.

The individual start zone or end zone or edit zone may be selected by contacting an area of a display screen of the electronic device immediately over the start zone, end zone or edit zone, etc. Alternatively, such as if the electronic device does not include a touch screen, the start zone, end zone, edit zone, etc. may be selected by depressing a key of the electronic device associated with the corresponding start zone, end zone, edit zone, etc.

Other features and advantages of the present invention will become apparent from the following more detailed description, taken in conjunction with the accompanying drawings, which illustrate, by way of example, the principles of the invention.

### BRIEF DESCRIPTION OF THE DRAWINGS

The accompanying drawings illustrate the invention. In such drawings:

FIG. 1 is a perspective diagrammatic view illustrating an electronic device incorporating the present invention;

FIG. 2 is a top and diagrammatic view illustrating the selection of a start zone, in accordance with the present invention;

FIG. 3 is a top and diagrammatic view illustrating the selection of an end zone for symbol data entry, in accordance with the present invention;

FIG. 4 is a diagram of a primary character array, used in accordance with the present invention;

FIG. 5 is a diagrammatic perspective view of an electronic device incorporating the present invention, with a semi-transparent screen thereof overlying a text data entry field;

FIG. 6 is a diagrammatic view of a transparency selection slider, used in accordance with the present invention;

FIG. 7 is a top view of an electronic device incorporating the present invention and illustrating an edit screen having a plurality of edit end zones with separate editing functions, in accordance with the present invention

FIG. 8 is a top view of an electronic device illustrating another start screen embodying the present invention;

FIG. 9 is a diagrammatic view of a shifted character array representing the start screen of FIG. 8;

FIG. 10 is a top view of an electronic device illustrating a numerical end screen, in accordance with the present invention;

FIG. 11 is a top view of an electronic device incorporating the present invention and illustrating a mathematical symbol screen, in accordance with the present invention; and

FIG. 12 is a perspective view of an electronic device having a keypad and incorporating the present invention.

### DETAILED DESCRIPTION OF THE PREFERRED EMBODIMENTS

As shown in the accompanying drawings, for purposes of illustration, the present invention resides in a method for inputting digital characters, such as into a display screen or command line of an electronic device. The present invention is particularly well suited for portable, hand-held devices having a touch screen, such as a smart phone, iTouch, iPad, or other such similar electronic devices. However, it is contemplated that the present invention could also be used in connection with portable and non-portable electronic devices having keys or physical buttons. It will be appreciated by those skilled in the art that the present invention is typically in the form of an algorithm or software application which is loaded onto an electronic device having a microprocessor, display, and data entry capabilities, such as a touch screen display or a keyboard or keypad or the like.

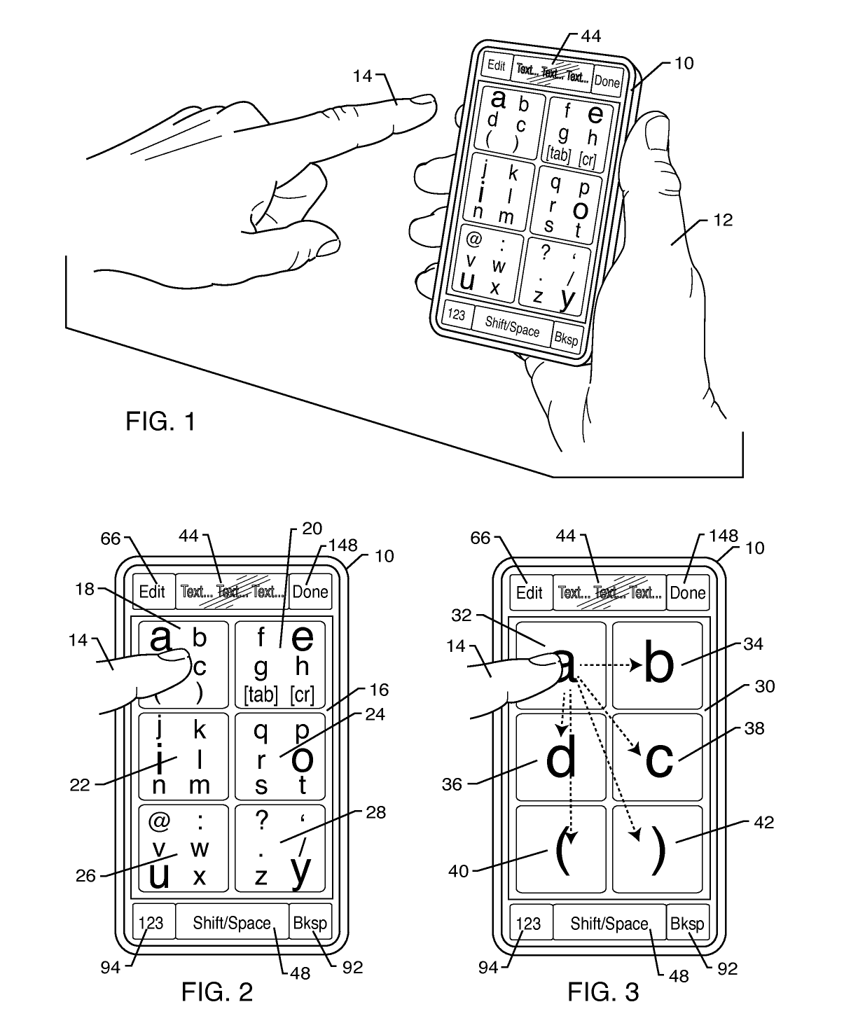

With reference now to FIG. 1, an electronic device 10 is illustrated incorporating the present invention. As described above, the electronic device 10 can comprise many different types of devices which have a microprocessor, memory, a display, and a means for data entry, such as a touch screen, keyboard, numeric pad, etc. The present invention is particularly adapted for hand-held devices having a touch screen display, such as smart phones, iPhone, iPad, and the like. Thus, the electronic device 10 illustrated in FIGS. 1-3, 5, 7-10 and 11 is illustrated representing such a hand-held smart phone or the like having a touch screen display.

The present invention resides in an algorithm or software application which provides an alternate way of inputting symbols, including alphabetical characters, numbers, numeric symbols, punctuation symbols, mathematic symbols, etc. into a data field entry of the electronic device 10. With reference now to FIGS. 1 and 2, the electronic device 10 may be held by the person's hand 12 and a finger 14 of the other hand is used to enter symbols and data and perform functions utilizing the present invention.

With reference now to FIG. 2, in accordance with the present invention, a start screen 16 is displayed on the electronic device 10. The start screen 16 may be selected by the user as a start screen or more typically is a standard, default start screen, as illustrated in FIG. 2. The start screen 16 has a plurality of start zones 18-28. Each start zone 18-28 has a plurality of symbols associated therewith.

In the embodiment illustrated in FIGS. 1 and 2, the start screen 16 includes six start zones 18-28, each start zone having a plurality of symbols in the form of lower case letters, punctuation, and tab and control functions. This is an exemplary character set for those speaking English and the alphabetical characters, punctuation symbols, and control functions which are typically used in creating text messages, data entry, and the like. Providing six start zones 18-28 enables six symbols or characters to be assigned to each start zone, representing the entire lower case English alphabet as well as common punctuation symbols. This 2×3 rectangular grid, forming the box-like start zones 18-28, each having the plurality of symbols or characters therein is particularly convenient in that each of the vowels (a, e, i, o, u and y) can be placed into a different start zone, with those consonant letters close thereto in the alphabet being assigned the same start zone, with the punctuation symbols added in to at least one of the start zones. Nearly all words in the English language include vowels, and arranging the alphabetical characters in this manner renders it easy for the user to remember the placement and find the desired alphabetical character within the start zone 18-28.

In accordance with a particularly preferred embodiment, start zone 18 includes the letters a, b, d, c and an open parenthesis punctuation symbol and a close parenthesis punctuation symbol. The second start zone 20 includes the letters e, f, g, h and the [tab] and [cr] (control) alphabetical letters and functions. The third start zone 22 includes the letters i, j, k, l, m and n. The fourth start zone 24 includes the letters o, p, q, r, s and t. The fifth start zone 26 includes the letters u, v, w, x, and the symbols “@” and “:”. The sixth start zone 28 includes the letters y and z, and the punctuation symbols “.”, ‘’’, “/”, and “?”.

It will be appreciated that the start screen 16 having start zones 18-28 representing the English language is shown for exemplary purposes. Typically, other Latin-based languages, such as Spanish, Italian, German, French, etc. would have a similar layout with similar characters, punctuation and like characters. Thus, the same 2×3 rectangular grid having six start zones in the start screen 16 is anticipated to be used for many other Latin-based languages due to the fact that these languages use alphabets and punctuation which closely resemble that of English. However, it will be appreciated by those skilled in the art that the number of start zones in the grid could be changed, such as to eight, nine, twelve, etc. so as to accommodate a different number of alphanumeric, pronunciation, and function character or symbol “keys”. For other languages, such as Russian, Chinese, Arabic, etc., a different grid structure might be required in order to accommodate the different number of commonly used characters.

Regardless of the number of start zones in the start or default screen 16, the start or default screen 16 will have a plurality of distinct boxes or virtual keys, referred to herein as zones, each start zone having a plurality of symbols (alphabetical characters, numbers, numeric symbols, punctuation symbols, mathematical symbols, etc.) associated therewith. As indicated above, in a particularly preferred embodiment, the alphabetical characters are in sequence from the upper left zone 18, and then moving to the right (zone 20), and then far left (zone 22), etc. such that it is intuitive to the user to find the vowel alphabetical character and the adjacent consonant alphabetical character.

In accordance with the present invention, a particular start zone 18-28 is selected utilizing the electronic device 10. In the embodiment illustrated in FIGS. 1-3, the electronic device 10 includes a touch screen display. Thus, as illustrated in FIG. 2, when a user contacts an area of the touch screen display screen of the electronic device 10 immediately over the start zone, such as the illustrated first start zone 18 in FIG. 2, an end screen 30 is displayed on the electronic device 10 having a plurality of end zones 32-42, each end zone 32-42 having assigned thereto a single symbol, in this case in the form of the alphabetical characters a, b, c, d, “)” and “(”, respectively.

In order to enter the desired symbol, such as the alphabetical lower case character “a” in end zone 32, the user utilizes the electronic device to select that particular end zone 32, in order to input the symbol assigned to the selected end zone into the data entry field 44 of the electronic device 10. When the electronic device includes a touch screen display, the user may tap and drag, wherein a line is drawn from the start zone to the end zone. That is, in the start screen as the first start zone is pressed and selected, the user can move his or her finger and swipe the selected end zone. A single contact motion may be used for selecting a start zone, and with a slight movement of the finger selecting the end zone if the start and end zones are in the same location. Thus, the arrows extending from end zone 32 to the other end zones 34-42 in FIG. 3 can represent the user moving his or her finger to press the touch screen display either by removing the finger and touching the touch screen display immediately above the selected end zone or moving or swiping the finger to the selected end zone.

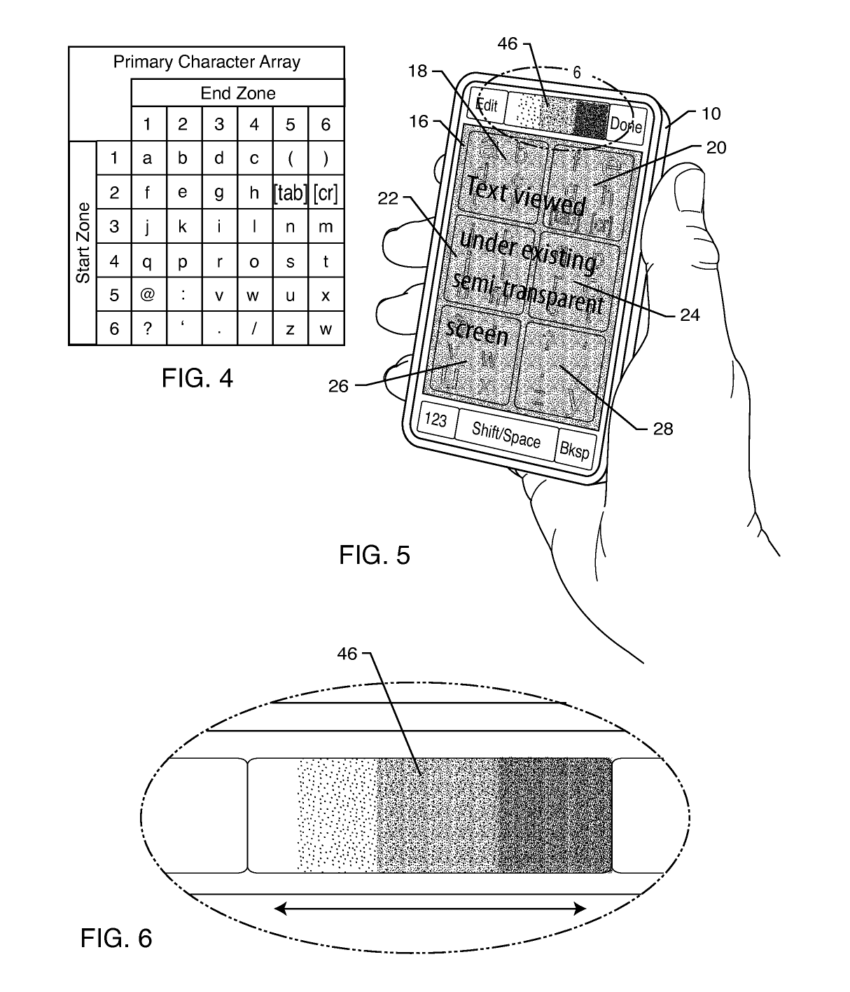

With reference now to FIG. 4, once the initial start zone, such as the illustrated 18 in FIG. 2, has been selected and the individual end zone, such as end zone 32 in FIG. 3 has been selected, the system of the present invention uses a lookup function to determine the symbol to be added to the text or other data entry being generated. This lookup function can use an array, a text file or strings, a database table or the underlying system's character code set. With reference now to the array illustrated in FIG. 4, the six start zones (18-28) form the rows of the array, and the corresponding six end zones (32-42) form the columns. Each combination of start zone and end zone corresponds to a specific symbol associated therewith. For example, selecting the first start zone (18), as illustrated in FIG. 2, of the start screen 16, and the first end zone (32) of the end screen 30 yields the inputting of the lower case alphabetical character “a” into the data entry field or text box 44. The two-dimensional array, such as illustrated in FIG. 4, can contain the symbols or characters themselves, or references to the characters or symbols in another source. The resulting symbol/character is added to the text being generated.

Thus, in accordance with the present invention the invention first determines the initial start screen and contact. The start contact is localized to a start zone. The start zone assigned number or identification is then obtained. The system then detects an end contact, and localizes the end contact to a particular end zone. The end zone number or identification is then obtained. The character or symbol or function is then looked up using the start zone number or identification and the end zone number or identification. The corresponding single symbol, character, function or the like is then added to the text string or the corresponding function performed.

For ease of illustration, the majority of the figures include a data entry field in the form of a text box 44 formed as a window within the screens 16 and 30 of the invention, such that the user can view the string of text, numbers, etc. generated while the data is input, in accordance with the present invention.

However, in a particularly preferred embodiment, as illustrated in FIGS. 5 and 6, the screen of the present invention, such as the illustrated start screen 16 is semi-transparent and overlays the data entry field of the electronic device 10, such that the text generated by the data entry utilizing the present invention is viewed under the existing semi-transparent screen. Typically, the screen will include a transparency selector 46, such that the transparency of the screen of the present invention can be made more transparent or less transparent, as illustrated in FIG. 6 by the directional arrow and corresponding shading. For those users who are familiar with the placement and assignment of symbols and characters into the different start and end zones of the present invention, a very transparent screen may be preferred such that the user can easily view the generated text under the semi-transparent screen of the invention. However, in other cases, such as when the user is not as familiar with the assignment of the symbols and characters into the different start and end zones of the present invention, the user may desire to make the screen of the present invention less transparent so as to more easily see the symbols and characters selected. Ambient lighting is also another consideration for the selection of the transparency of the screen.

It is contemplated by the present invention that the user may select or choose a start screen. However, in a particularly preferred embodiment, the start screen 16, such as that illustrated in FIGS. 1 and 2, comprises a default start screen. Once the symbol, character, or function of the selected end zone is inputted or performed, the system of the present invention automatically returns the user to the start screen, preferably the default start screen.

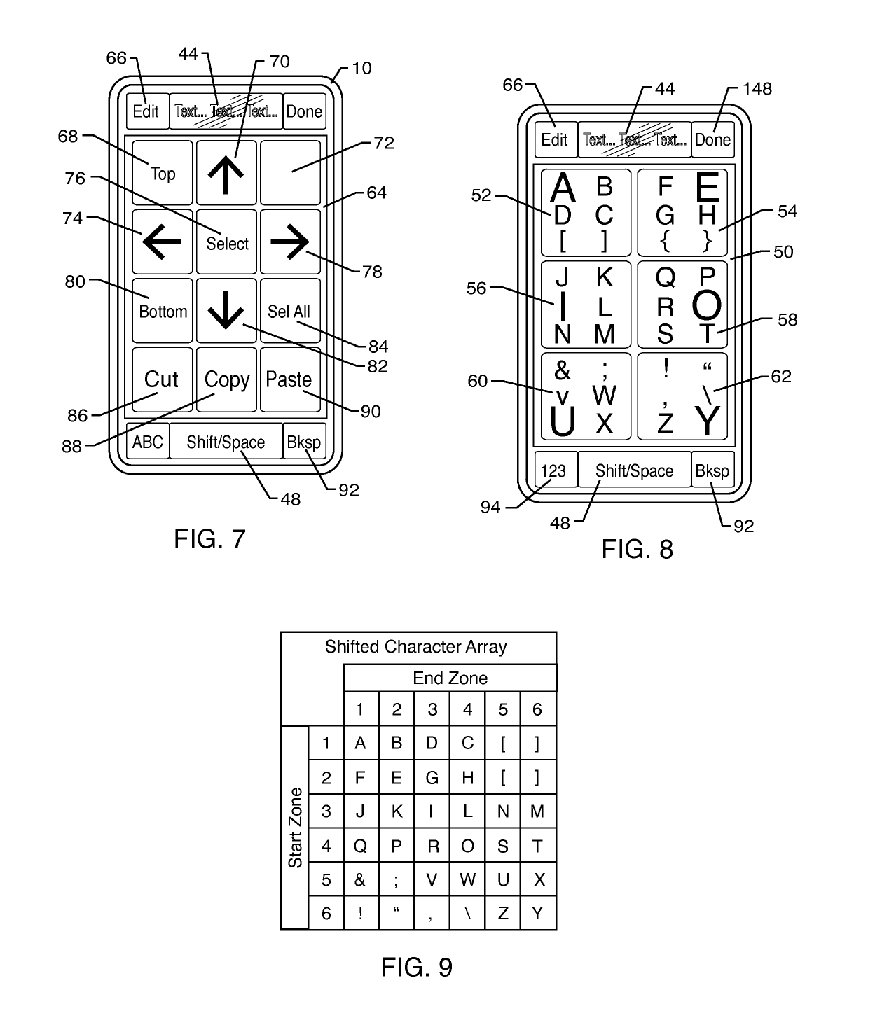

With reference now to FIGS. 2 and 7, a shift/space button or zone 48 is typically included in at least the start screen 16, and preferably in all screens of the present invention. Depressing this button or zone 48 can create a space between the string of characters. This button or zone 48 can also be used to select another start screen, typically the upper case alphabetical characters and other punctuation symbols start screen, as illustrated in FIG. 8.

For example, the shift/space bar or zone 48 can be held for a prolonged period in order to select the upper case start screen 50, illustrated in FIG. 8. The upper case start screen 50 once again includes six start zones 52-62, preferably arranged with the same letter assignments, but the letter characters being upper case as opposed to lower case. Different punctuation symbols can be assigned to the various one or more upper case start screen start zones 52-62. Alternatively, once the shift/space bar button or zone 48 is pressed once, the input screen shifts to the upper case start screen 50. If a character is selected from the upper case start screen 50, it is entered into the text field and the screen returns to the start or default screen, and the shift/space button or zone 48 returns to neutral. However, if the shift/space zone 48 is pressed again before a character is selected, a space is entered in the text field and the input area returns to the start screen, as discussed above.

An upper case letter or different punctuation symbol is selected, as described above with respect to FIGS. 2 and 3, by selecting, such as contacting the touch screen display immediately above the start zone 52-62, in order to yield an end screen (not shown) having a plurality of end zones, each end zone being assigned a specific symbol, in this case in the form of an upper case letter character or punctuation symbol. Selecting a particular end zone inputs the upper case letter character or punctuation symbol into the data entry field and into the line of text being generated.

Similar to that described above with respect to FIG. 4, a shifted character array is illustrated in FIG. 9, with each of the start zones being assigned an identifier, in this case numbers 1-6, forming the rows of the array. The end zones are also labeled with an identifier, in this case 1-6, such that the logic of the system can associate a selected start zone and a selected end zone to yield a particular symbol or character to be input into the data entry field.

The present invention contemplates that errors will be made during the text or other data entry process, or the data or text string will be desirably edited occasionally. The user may select an edit screen 64, such as by selecting an edit button or zone 66 in the default screen, such as illustrated in FIG. 2, or in other screens showing the edit button or zone 66.

With reference now to FIG. 7, once the edit screen 64 has been selected, a plurality of individual edit zones 68-90 are displayed on the electronic device and actuatable and selectable by the user. The individual edit zones may be selected, each edit zone being assigned a particular edit function, such that when the edit zone is selected, this results in the assigned edit function to be performed in the data entry screen. This allows, for example, the replacement of a cursor, cutting, copying, and pasting text, going to the bottom or top of a character string or page, and other common editing functions and features. It will also be seen that in at least the start screens, with the possibility also of inclusion in the end screens, is a back space “bksp” button or feature 92 which can be used to back space and clear an erroneously entered character or symbol without the need of entering into the editing screen 64. This is due to the fact that a “back space” or “clear” function is more commonly needed when creating a text string.

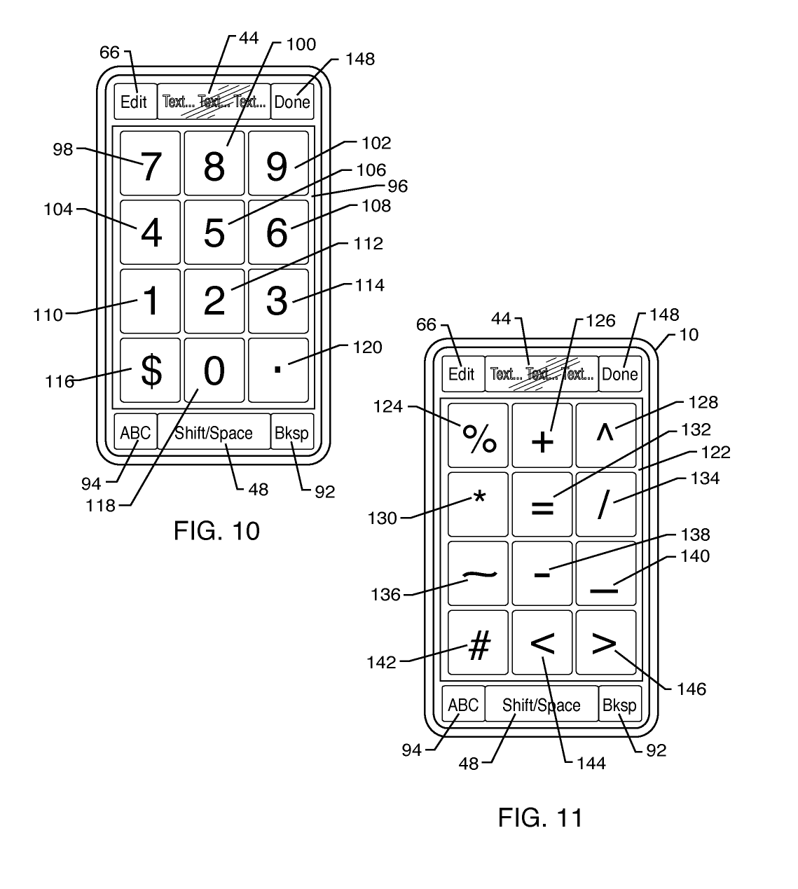

With reference again to FIG. 2, in the default start screen, and possibly other start screens or even end screens, a zone or button 94 is included which enables the user to select a numeric screen 96, as illustrated in FIG. 10. The numeric screen 96 typically includes twelve individual zones 98-120, ten of the twelve zones including a single numeral digit 0-9. Illustrated in FIG. 10 the additional zone 116 has the dollar symbol and zone 120 includes a period symbol. This enables the user to easily enter monetary values.

It will be seen from FIG. 10 that the numerical zones 98-120 are arranged similar to a ten-key keypad such that zone 98 is assigned numeral 7, zone 100 is assigned numeral 8, zone 102 is assigned numeral 9, zone 104 is assigned numeral 4, zone 106 is assigned numeral 5, zone 108 is assigned numeral 6, zone 110 is assigned numeral 1, zone 112 is assigned numeral 2, zone 114 is assigned numeral 3, and zone 118 is assigned numeral 0. It will also be understood that the assignment of the numbers may be changed such that they follow from the upper left corner to the lower right corner the numbers in sequence from 1 to 9 in zones 98-114, with the numeral 0 being assigned to zone 118, similar to telephone keypads.

Selecting the shift/space button or bar 48 while in the numeric screen 96 results in the display on the electronic device 10 of a mathematical symbol and function screen 122. In the illustrated example, twelve zones 124-146 are illustrated, each zone being assigned a distinct mathematical symbol or function, such as the “+” symbol which can also serve the function of addition, etc. In this manner, the user may either enter numbers and mathematical symbols into the data field as a text string, or perform mathematical functions, depending upon the design of the system.

It will be seen in FIGS. 10 and 11 that when in the numeric and mathematical character screens 96 and 122, the numeric screen button 94 is transformed to a “alphabetical” button, such that depressing or selecting the alphabetical button will return the user to the start screen having the alphabetical symbols within the start zones thereof, and typically the default start screen 16 illustrated in FIG. 2.

When the user is finished or done with the text screen or data entry, the user may exit from the invention, such as depressing the “done” button or zone 148, which is at least on the default start screen, illustrated in FIG. 2, but may be on one or more additional screens.

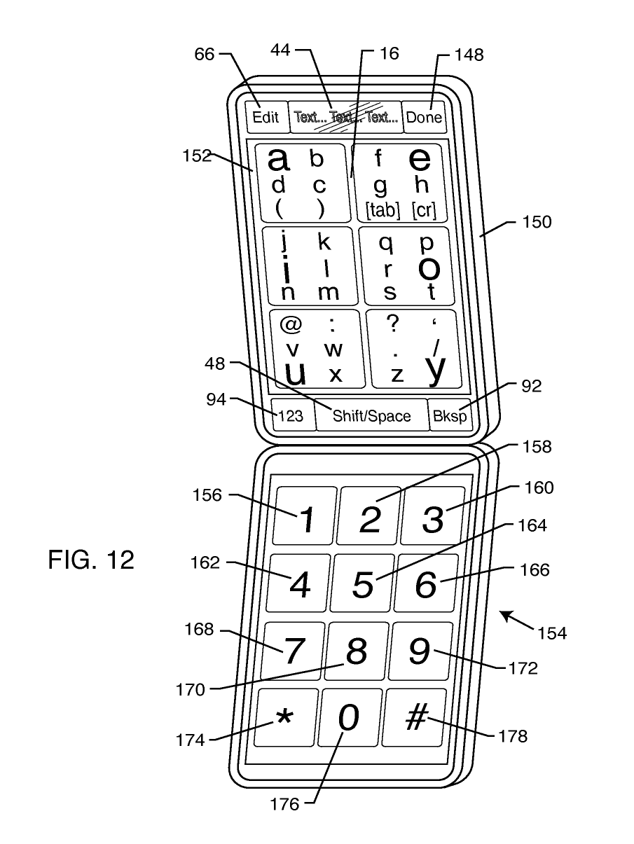

With reference now to FIG. 12, while the present invention is particularly adapted for use in connection with electronic devices having a touch screen activated display, such as smart phone, iPads, and the like, the present invention can also be incorporated and used with electronic devices having physical keyboards and keypads. FIG. 12 illustrates such an electronic device 150, which can comprise a cellular phone having a non-touch screen display 152 and a keypad 154. The electronic display will display a screen, such as the illustrated default start screen 16. However, since the display is not a touch screen, physical keys or buttons 156-178 are used to select the start and end zones. For example, if the user wanted to select the fourth start zone illustrated in FIG. 12, having assigned thereto lower case characters o, p, q, r, s, and t, the user would depress the key 166 (labeled 6). Once the end screen and the individual end zones were illustrated on the display (not shown), a corresponding physical key could be depressed on the keypad 154 to select that symbol, character, etc.

It will be appreciated that in the electronic device 150 shown in FIG. 12, the “star” button can represent the switching between numeric, mathematical, and alphabetical screens, the “0” button can be used for the shift/space bar or button, and the “#” key or button can be used as the back space button. However, these keys, when presented with a twelve-zone grid, can represent other characters or functions.

Although a cell phone having a physical keypad 154 is illustrated, other devices having a keypad or keyboard having individual physical keys associated with a screen thereof could also implement the present invention. Such could include other hand-held devices, desktop computers, etc.

It will be appreciated by those skilled in the art that the present invention provides alternatives and advantages to existing data entry methods and systems. While many smart phones require the user to utilize both hands and thumbs in entering data utilizing very small virtual or physical keys, which can result in errors, the present invention can be used with a single hand with the finger or thumb of the user contacting and selecting individual start zones and end zones to select letters, characters, functions, etc. as described above. A six-zone grid display is particularly advantageous in the sense that it is relatively large and easy to see and select with one's thumb on the display screen of the hand-held device. Thus, the device can be held farther away from the user's face while still being able to easily discern the letters and characters of the data character display screen.

Although several embodiments have been described in detail for purposes of illustration, various modifications may be made without departing from the scope and spirit of the invention. Accordingly, the invention is not to be limited, except as by the appended claims.

What is claimed is:

1. A method for inputting symbols into a data entry field of an electronic device, comprising the steps of:
displaying on the electronic device a start screen having a plurality of start zones, each start zone having a plurality of symbols associated therewith;
selecting a start zone using the electronic device;
displaying on the electronic device an end screen having a plurality of end zones, each end zone having assigned thereto a single symbol of the plurality of symbols associated with the selected start zone;
selecting an end zone using the electronic device; and
inputting the symbol assigned to the selected end zone into the data entry field of the electronic device.

2. The method of claim 1, wherein the symbols comprise alphabetical characters, numbers, numeric symbols, punctuation symbols, or mathematical symbols.

3. The method of claim 1, wherein the end screen comprises at least a plurality of end zones each assigned a letter character symbol or a punctuation symbol.

4. The method of claim 1, wherein the start screen comprises a default start screen.

5. The method of claim 4, including the step of automatically returning to the start screen when a symbol has been inputted into the data entry field.

6. The method of claim 4, including the step of selecting a start screen.

7. The method of claim 1, including the step of selecting an edit screen, and the electronic device displaying an edit screen having a plurality of edit zones, each edit zone being assigned an edit function when the edit zone is selected, and wherein selecting an edit zone results in the assigned edit function being performed in the data entry screen.

8. The method of claim 1, wherein the start zone or end zone is selected by contacting an area of a display screen of the electronic device immediately over the start zone or end zone.

9. The method of claim 1, wherein the start zone and end zone are selected by depressing a key of the electronic device associated with the start zone or end zone.

10. The method of claim 1, including the step of including an area in at least the end screen comprising the data entry field.

11. The method of claim 1, wherein at least the end screen is semi-transparent and at least partially overlays the data entry field.

12. The method of claim 11, including the step of selectively altering the transparency of the end screen.

13. A method for inputting symbols into a data entry field of an electronic device, comprising the steps of:
displaying on the electronic device a start screen having a plurality of start zones, each start zone having a plurality of symbols associated therewith;
selecting a start zone by contacting an area of a display screen of the electronic device immediately above the selected start zone;
displaying on the electronic device an end screen having a plurality of end zones, each end zone having assigned thereto a single symbol of the plurality of symbols associated with the selected start zone;
selecting an end zone by contacting an area of a display screen of the electronic device immediately above the selected end zone; and
inputting the symbol assigned to the selected end zone into the data entry field of the electronic device;
wherein the symbols comprise alphabetical characters, numbers, numeric symbols, punctuation symbols, or mathematical symbols.

14. The method of claim 13, wherein the end screen comprises at least a plurality of end zones each assigned a letter character symbol or a punctuation symbol.

15. The method of claim 13, wherein the start screen comprises a default start screen.

16. The method of claim 15, including the step of automatically returning to the start screen when a symbol has been inputted into the data entry field.

17. The method of claim 15, including the step of selecting a start screen.

18. The method of claim 13, including the step of selecting an edit screen, and the electronic device displaying an edit screen having a plurality of edit zones, each edit zone being assigned an edit function when the edit zone is selected, and wherein selecting an edit zone results in the assigned edit function being performed in the data entry screen.

19. The method of claim 13, including the step of including an area in the end screen comprising the data entry field.

20. The method of claim 13, wherein the end screen is semi-transparent and at least partially overlays the data entry field.

21. The method of claim 20, including the step of selectively altering the transparency of the end screen.
